(19) United States
(12) Patent Application Publication
(10) Pub. No.: US 2014/0313016 A1
(43) Pub. Date: Oct. 23, 2014

(54) MASTER AND SLAVE RFID TAGS FOR SYSTEM AND METHOD OF EQUIPMENT MANAGEMENT

(71) Applicant: AIRBUS (S.A.S), 31700 (FR)

(72) Inventors: Carlo NIZAM, TOULOUSE (FR); Farid HASSANI, TOULOUSE (FR)

(21) Appl. No.: 14/253,461

(22) Filed: Apr. 15, 2014

(30) Foreign Application Priority Data
Apr. 16, 2013 (FR) 1353448

(51) Int. Cl. G06K 7/00; G06K 7/10

(52) U.S. Cl. CPC G06K 7/0008; G06K 7/10297; G06K 7/10356
USPC 340/10.5; 340/10.1

(57) ABSTRACT

Systems and methods are disclosed to adapt RFID tags in a master-slave configuration and to connect them by a connector. Upon a request from a reader, the slave RFID tag will transmit via the connector data to the master RFID tag which will concatenate the latter with its own data and transmit a concatenated series of data to the reader. Such RFID tags are presented in use in a system for managing a plurality of equipment stored in a plurality of housings, as is the case for a room of IT servers. Each such slave RFID tag is fastened preferably onto a housing, contains information on the housing, and is connected to the master RFID tag preferably fastened onto the equipment stored in the housing and containing information on the equipment. A user thereby knows in a single reading information about the equipment and the housing that it occupies.

### CROSS-REFERENCE TO RELATED APPLICATION

This application claims priority to French Patent Application No. 13 53448 filed on Apr. 16, 2013, the entire content of which is incorporated by reference herein.

### BACKGROUND

The subject matter disclosed herein relates to a system for managing by Radio Frequency IDentification tags (RFID tags) equipment arranged in various housings.

In the field of equipment management, for example of management of electronic equipment such as servers, the use of RFID tags is known, typically by associating an RFID tag with each equipment. This makes it possible to know at any moment, by performing a reading of the RFID tags, which equipment is present in a given read zone, such as a room or a warehouse. However, the reading of an RFID tag does not give the location of an RFID tag with precision.

U.S. Pat. No. 6,600,418 describes a system for locating and managing objects using RFID tag assemblies. Objects that must be moved between various positions are equipped with RFID tags including information on the identities of the objects. The positions also include RFID tags containing information on the positions. A transport vehicle intended to move the objects is equipped with an RFID tag reader. A processor incorporated into the reader sends information on the identity of a moved object and on the sitting of the vehicle to an operator, and gives instructions on the motion of the objects to the operator of the vehicle in order to move them to the appropriate position. U.S. Pat. No. 6,669,089 describes an improvement of such a system and proposes a combination of a plurality of RFID antennas, a first on a fixed part of the mast of a forklift truck and at least a second on the mobile part of the forklift truck, each of the antennas being able to interrogate an RFID tag fixed on an object. Thus it is possible to know the exact position of an object present on the forklift truck. However, such a system does not make it possible to associate the information contained in the RFID tag of the position with the information contained in the RFID tag of the equipment into a single item of information in order to know the position of each object after it has been moved.

The subject of the subject matter disclosed herein aims to remedy all or part of the aforementioned drawbacks.

### SUMMARY

A first aspect of the subject matter disclosed herein relates to a system for managing a plurality of equipment stored in a plurality of housings. The management system comprises a reader, a plurality of RFID tags of a first type, denoted slave, each comprising a transmitter and a plurality of RFID tags of a second type, denoted master, each also comprising a transmitter. The management system according to the subject matter disclosed herein is noteworthy in that each housing includes an RFID tag of one type, either master or slave, and each equipment includes an RFID tag of the other type which is connected via a connector to the RFID tag of the housing in which the equipment is stored. Moreover, each RFID tag of the master type is configured to transmit to the reader a series of data output by the slave RFID tag to which it is connected and a series of data output by the master RFID tag, in response to the request of a reader.

According to a preferred embodiment, each housing of the management system according to the subject matter disclosed herein includes a slave RFID tag and each equipment of the management system according to the subject matter disclosed herein includes a master RFID tag.

Advantageously, the management system according to the subject matter disclosed herein moreover includes a connector on each slave RFID tag configured to receive the connector or a free connector, denoted inhibitor, configured to be connected to the connector.

In the preferred embodiment, each slave RFID tag of the management system according to the subject matter disclosed herein comprises:
a mechanism for detecting a connection on the connector;
an inhibitor configured to deactivate the transmitter of the RFID tag, in the event of a connection being detected on the connector; and
a sender configured to send a series of data in response to a request from the reader, in the event of a connection on the connector.

In the preferred embodiment, each master RFID tag of the management system according to the subject matter disclosed herein comprises:
a receiver configured to receive a series of data originating from the slave RFID tag connected to the master RFID tag;
a mechanism for detecting a connection of the receiver; and
a concatenator configured to concatenate the series of data received from the slave RFID tag with another series of data into a concatenated series of data, intended to be transmitted to the reader in response to a request from the reader.

In a variant embodiment, at least one of the master RFID tags of the management system according to the subject matter disclosed herein comprises a connector for connecting to the slave RFID tag.

In another variant embodiment, the connector of the management system according to the subject matter disclosed herein is chosen from among a cable and a jumper wire.

According to a second aspect, the subject matter disclosed herein proposes a method for managing a plurality of equipment stored in a plurality of housings. The management method according to the subject matter disclosed herein implements a management system according to the subject matter disclosed herein, described above, and comprises a step of the reader emitting a request in the direction of a housing and of the reader receiving a series of data. The method according to the subject matter disclosed herein is noteworthy in that it comprises, for each housing receiving equipment, a step of connecting the RFID tag associated with the housing to the RFID tag associated with the equipment stored in the housing or to an inhibitor.

In one embodiment, the method according to the subject matter disclosed herein includes, for each equipment stored in a housing, subsequently to the step of connecting the slave RFID tag, a step of the master RFID tag concatenating a series of data received from the slave RFID tag with a series of data output by the slave RFID tag.

### BRIEF DESCRIPTION OF THE DRAWINGS

Other features, details and advantages of the subject matter disclosed herein will become clearer from the detailed description given below for indicative purposes, with reference to the appended drawings in which:

FIG. 1 illustrates an electronics rack comprising housings able to receive equipment;

FIG. 2 illustrates an RFID tag of slave type connected with an RFID tag of master type;

FIG. 3 illustrates an RFID tag of slave type according to the subject matter disclosed herein;

FIG. 4 illustrates an RFID tag of master type according to the subject matter disclosed herein;

FIG. 5 illustrates a slave RFID tag connected to an inhibitor according to the subject matter disclosed herein;

FIG. 6 illustrates a concatenation of series of data; and

FIG. 7 illustrates a room comprising several electronics racks.

### DETAILED DESCRIPTION

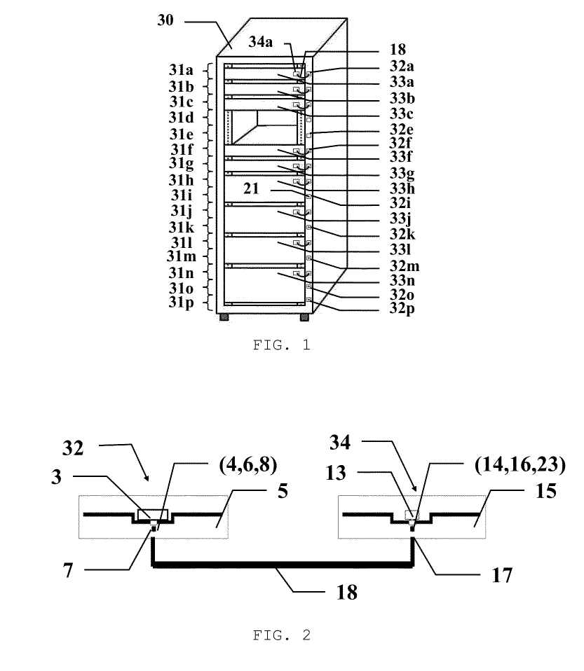

FIG. 1 illustrates a system for managing an electronics rack 30 including a plurality of housings 31 and a plurality of equipment 33 arranged in said housings 31. In the example shown, the rack 30 includes sixteen housings generically denoted 31 and individually denoted 31a-p. In these various housings 31 are placed equipment, here nine in number, generically denoted 33 and individually denoted 33a-c,f-h,j,l,o. The equipment 33 shown are of single 33a-c,f,g, double 33h,j,l or triple 33o size.

Equipment 33 of single size (1 unit) denotes equipment that is received in any single housing 31. Consequently, equipment 33 of double size is equipment that is received in two contiguous housings 31. Similarly, equipment 33 of size n is equipment that is received in n contiguous housings 31.

According to an embodiment of the subject matter disclosed herein, each housing 31 is associated with a slave RFID tag generically denoted by the reference 32 and individually denoted by the references 32a-32p and each equipment 33 is associated with a master RFID tag denoted by the reference 34 and individually denoted by the reference 34a-c,f-h,j,l,o.

As illustrated in FIG. 1, the RFID tags are fixed by adhesion or any other equivalent means onto the equipment or onto an edge of the cabinet forming the rack facing the housing 31 with which they are associated.

As illustrated in FIG. 2, the slave RFID tag 32 of the housing 31 is connected by a jumper wire or a cable 18 to the master RFID tag 34 of the equipment 33 placed in the housing. In the case of multiple housings 31 being occupied by one equipment 33, the housing 31 of which the RFID tag 32 is connected is chosen arbitrarily. Thus in the example illustrated, the first housing 31 occupied starting from the top is selected. Any other choice would be possible.

As illustrated in FIG. 3, each RFID tag 32 of slave type comprises, in a known manner, a base 2 on which a processor 3 or chip is arranged, connected to an antenna 5. An RFID tag of slave type 32 is typically passive, in that it does not include its own power source. An RFID tag of slave type 32 is able to be interrogated by a reader 22. To do this the slave RFID tag 32 also comprises a transmitter 4. This transmitter 4 comprises hardware devices, including the antenna 5, and a software part accessible to the chip 3. This transmitter 4 is able to transmit wirelessly a series of housing data 9 specific to the slave RFID tag 32 in response to a request from a reader 22. The series of housing data 9 of a slave RFID tag 32 comprises information characterizing said housing 31 such as the position of the RFID tag in the rack 30 and/or in the room 35 (as will be described below), its dimensions in the case where not all the housings 31 have the same dimensions, or any other feature beneficial to a management system. Such information can be expressly included in the series of housing data 9.

According to an embodiment of the subject matter disclosed herein, each slave RFID tag 32 comprises a sender 6 and a connector 7. This sender 6 comprises hardware devices, including the connector 7, and a software part accessible to the chip 3.

Each slave RFID tag 32 furthermore comprises an inhibitor 8 for inhibiting the transmitter 4 allowing the disconnection of the antenna 5 from the transmitter 4 of the RFID tag 32. This inhibitor 8 comprises hardware devices such as an interface with the connector 7, an interface with the transmitter 4 and/or the antenna 5 and a software part accessible to the chip 3.

The detection of the connection of the sender 6 is performed, preferably, by a mechanism of switch type arranged in the connector 7. The mechanism is actuated by the introduction into the connector 7 of a mating connector.

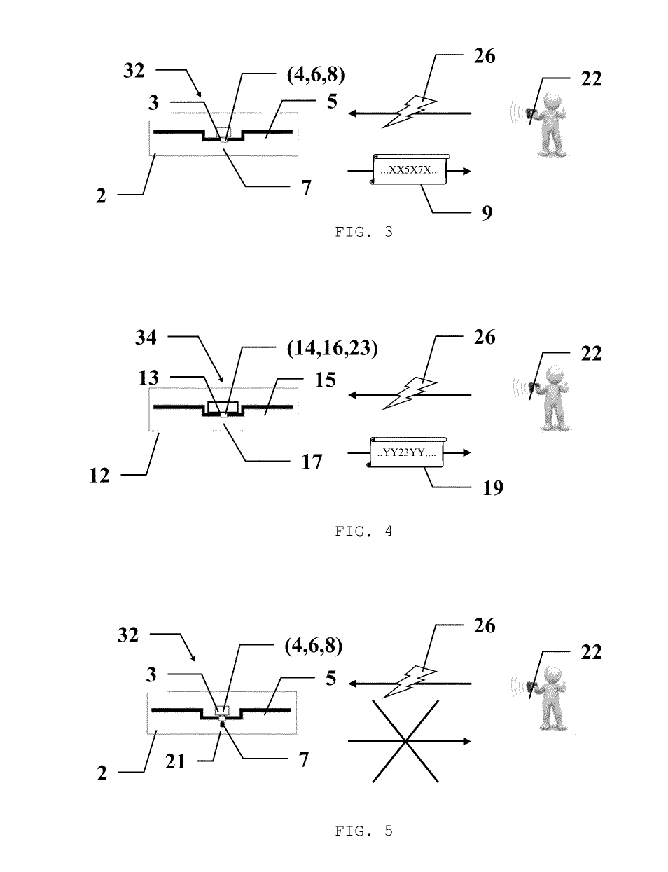

In a manner similar to the slave RFID tag 32, each RFID tag of master type 34 (illustrated in FIG. 4) comprises a base 12 on which a processor 13 or chip is arranged, connected to an antenna 15. The master RFID tag 34 is typically passive, in that it does not include its own power source. Each master RFID tag 34 is able to be interrogated by a reader 22. To do this each master RFID tag 34 comprises a transmitter 14. This transmitter comprises hardware devices, including the antenna 15 and a software part accessible to the chip 13. This transmitter 14 is able to transmit wirelessly a series of equipment data 19 specific to the master RFID tag 34 in response to a request from a reader 22.

According to the subject matter disclosed herein, each master RFID tag 34 comprises a receiver 16 and a connector 17. This receiver comprises hardware devices, including the connector 17 and a software part accessible to the chip 13. This receiver 16 is selectively connectable, in that it can be connected in order to establish a connection or disconnected, according to choice.

The receiver 16 allows the master RFID tag 34 to connect via a cable or jumper wire 18 to the sender 6 of a slave RFID tag 32 and to receive the series of data 9 from said slave RFID tag 32.

The detection of the connection of the receiver 16 is performed, preferably, by a mechanism of switch type arranged in the connector 17. The mechanism is actuated by the introduction into the connector 17 of a mating connector.

In a manner similar to the slave RFID tag, the series of equipment data 19 comprises information characterizing said equipment 33. Thus can be characterized the dimension of the equipment in numbers of necessary housing units, or the model of the equipment 33, its series number, its software version, its power, its number of processable rows, its bandwidth, or any other specification of the equipment, or any other feature beneficial to a management system.

Each master RFID tag 34 also comprises a concatenator 23. As illustrated in FIG. 6, such a concatenator 23 according to the subject matter disclosed herein is configured to concatenate the series of equipment data 19 specific to the master RFID tag 34 with the series of housing data 9 received from a slave

RFID tag 32. This concatenation forms a new series of data, which will be named concatenated series of data 24.

It will be noted that a series of housing data 9 or equipment data 19, from a slave RFID tag 32, or a master RFID tag 34 respectively, comprises a type IDentification, indicating that it is an RFID tag of slave or master type respectively.

The type indicator makes it possible, among other things, not to impose any order for concatenating two series of data.

It will be noted that so as not to have to modify the series of housing data 9 or equipment data 19 and to not be limited by its storage size, all these data can be stored in a more easily editable table, and indexed by a single IDentification, for example.

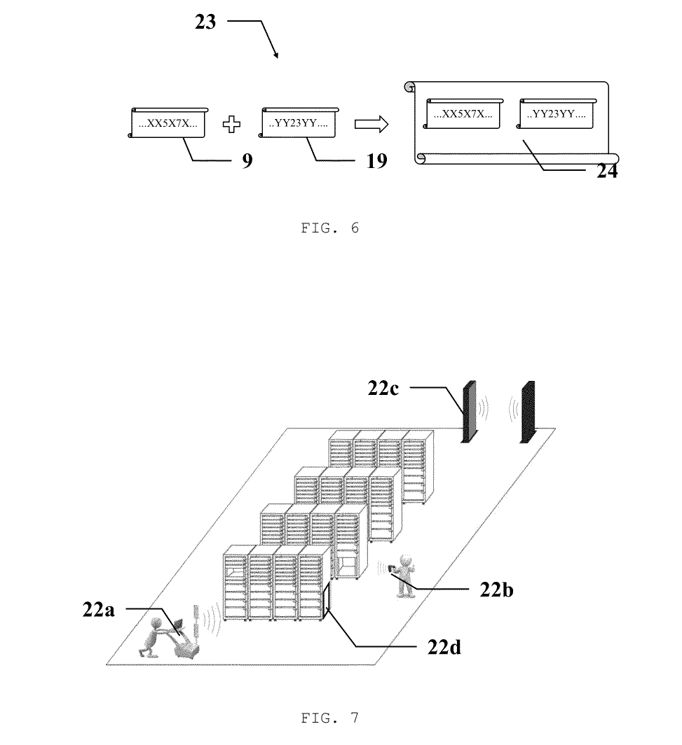

FIG. 5 illustrates a slave RFID tag of a housing, connected to an inhibitor 21.

Such an inhibitor 21 takes the form of a connector similar to the connector present at the end of the cable 18. In the absence of a complete cable 18, no link with a master RFID tag 34 is made, but the slave RFID tag 32 “sees” a connection. Thus the inhibitor 8 is actuated and deactivates the transmitter 4. It should be noted that such a slave RFID tag 32 connected to an inhibitor 21 is then rendered totally mute.

The operation of the management system according to the subject matter disclosed herein will now be described with reference to FIG. 7.

In this example, the equipment 33a/RFID tag 34a is associated with or connected to the housing 31a/RFID tag 32a. The equipment 33b/RFID tag 34b is associated with or connected to the housing 31b/RFID tag 32b. The equipment 33c/RFID tag 34c is associated with or connected to the housing 31c/RFID tag 32c.

The two housings 31d-e/RFID tags 32d-e are free or disconnected.

The equipment 33f/RFID tag 34f is associated with/connected to the housing 31f/RFID tag 32f. The equipment 33g/RFID tag 34g is associated with/connected to the housing 31g/RFID tag 32g. The equipment 33h/RFID tag 34h is associated with/connected to the housing 31h/RFID tag 32h.

The housing 31i is occupied by the equipment 33h, but its RFID tag 32i is not connected to an RFID tag. On the contrary, the RFID tag 32i is inhibited by introducing an inhibitor 21.

The equipment 33j/RFID tag 34j is associated with/connected to the housing 31j/RFID tag 32j.

The housing 31k is occupied by the equipment 33j, but its RFID tag 32k is not connected to an RFID tag. On the contrary, the RFID tag 32k is inhibited by introducing an inhibitor 21.

The equipment 33l/RFID tag 34l is associated with or connected to the housing 31l/RFID tag 32l.

The housing 31m is occupied by the equipment 33l, but its RFID tag 32m is not connected to an RFID tag. On the contrary, the RFID tag 32m is inhibited by introducing an inhibitor 21.

The equipment 33n/RFID tag 34n is associated with or connected to the housing 31n/RFID tag 32n.

The housings 31o-p are occupied by the equipment 33n, but their RFID tags 32o-p are not connected to an RFID tag. On the contrary, the RFID tags 32o-p are inhibited by introducing an inhibitor 21 into each.

Thus, during interrogation by reader 22 of the management system, the following discriminating responses are obtained:
the master RFID tag 34, the associated equipment 33 of which is arranged in a housing 31 is connected with the slave RFID tag 32 of one of the housings 31 occupied by the equipment 33. This is the case of the pairs of equipment RFID tags 34a-c,f,h,j,l,n associated with the housing RFID tags 32a-c,f,h,j,l,n respectively.

This connection is performed manually by an operator who connects a jumper wire/cable 18 between the two RFID tags 32, 34 after having put equipment 33 in place in its housing(s) 31.

Upon this connection, the detector for detecting the slave RFID tag 32 detects a connection of the sender 6 to a master RFID tag. In response to this detection, the inhibitor 8 deactivates the transmitter 4. Thus, the RFID tag 32 is no longer able to respond to a request from the reader 22.

The detector for detecting the master RFID tag 34 detects a connection of the receiver 16 of the master RFID tag with the sender 6 of the slave RFID tag 32. Thus, the master RFID tag 34 can receive the series of housing data 9 originating from the slave RFID tag 32.

After receiving the series of housing data 9 from the slave RFID tag, the concatenator 23 assembles the series of housing data 9 with the series of equipment data 19 to form the concatenated series of data 24.

The transmitter 14 of the master RFID tag 34 transmits said concatenated series of data 24 in response to the request from the reader 22. In this way the series of housing data 9 received from the slave RFID tag 32 is relayed by the master RFID tag 34 in order to be transmitted to the reader 22.

It is understood that such a connected pair of master 34 and slave 32 RFID tags will transmit a concatenated series of data 24 comprising on one hand the series of equipment data 19 and on the other hand the series of housing data 9. This concatenated series of data 24 informs that such equipment 33 is arranged in such housing 31 and thus that the corresponding housing 31 is occupied.
The slave RFID tag 32, whose the associated housing 31 is free, such as the RFID tags 32d-e, will transmit its series of housing data 9 alone. The reception by the reader 22 of a series of housing data alone indicates an empty housing 32.
The slave RFID tag 32, whose the associated housing 31 is occupied by an equipment occupying several housings 31 and the master RFID tag of which is already connected to a slave RFID tag, is connected to inhibitor 21, such as the RFID tags 32i,k,m,o-p.
This connection to an inhibitor is performed manually by an operator who connects an inhibitor 21 to the connector 7 of the slave RFID tag 32.

Upon this connection, the detector for detecting the slave RFID tag 32 detects a connection of the sender 6 to a master RFID tag. In response to this detection, the inhibitor 8 deactivates the transmitter 4. Thus, the RFID tag 23 is no longer able to respond to a request from the reader 22.

In response to the request from the reader 22, such a slave RFID tag 32 will not transmit any series of data. The total of present housings 31 being known, the absence of direct reception by the reader 22 of an alone series of data 9, can be determined by measuring the difference, and indicates an occupied housing 31.
The master RFID tag 34, whose the associated equipment 33 is not arranged in a housing 31, corresponding for example to one equipment 33 in reserve, not being connected, will transmit its series of equipment data 19 alone. Thus, the reception by the reader 22 of an alone series of equipment data 19 indicates an equipment 33 that is not arranged in a housing 31 and therefore available.

An inhibitor 21 can be associated with a master RFID tag of such an equipment to indicate a non-functional equipment 33 and thus distinguish it from a functional equipment 33 in reserve.

Although the management system according to the subject matter disclosed herein described above employs a slave RFID tag 32 for the housings 31 and a master RFID tag 34 for the equipment 33, it is possible to invert the RFID tags while complying with the fact that the RFID tags associated with the equipment 34 are of a type, either slave or master, different from the type of the RFID tags associated with the housings 31.

FIG. 8 illustrates the application of the management system according to the subject matter disclosed herein to an electronics/IT room 5. In this room 35 are arranged, in a known manner, several racks 30 comprising housings 31 able to receive equipment 33.

Various types of readers are also illustrated, generically denoted 22 and individually 22a-d. A reader 22 can thus be a mobile reader. It is thus possible to discern a reader 22a carried by a mobile trolley able to be moved or to move autonomously in the room 35 or else a reader 22b, lighter, in order to be portable by an operator. A reader 22 can also be a fixed reader, such as a reader 22d installed at a fixed station on a rack 30 or on a wall of the room 35. Another fixed reader is a reader 22c arranged at the level of the door of the room 35. Such a reader 22c is particularly advantageous in that it detects any entry or exit of equipment 33 and/or of a housing 31. This makes it possible to automatically keep updated an inventory of the contents of the room 35.

One or more of these readers 22, where applicable in collaboration, allow the system to interrogate/read all the RFID tags as slave associated with the 32 that master 34 and to collect all the corresponding series of data in order to establish an inventory at a given instant of the contents of the room 35. Such an interrogation can be performed periodically or on request when the configuration is modified. Such a set of readers 22 collects all the simple or concatenated series of data. These series of data are then processed. This processing can be performed by the reader(s) 22 and/or by a dedicated software package.

Such a management system according to the subject matter disclosed herein comprises a human-machine interface able to present the processed information.

This human-machine interface comprises a display for displaying the configuration of the type at least one display screen and a processing and display software package. The display displays a schematic map positioning the various housings 31. On this schematic map, the display displays, in overlay, information arising from the processed series of data.

Such a display, possibly modifiable on demand as a function of the particular features that one wishes to make appear, allows an operator to obtain a global picture of the configuration, in order to know which equipment 33 is arranged in which housing(s) 31, which housing 31 is empty/available, etc. Other synthetic data can also be determined and displayed, such as number of empty housings 31, numbers of occupied housings 31, total aggregated capacity or power of the equipment 33, map of the surrounding conditions etc., in an ergonomic form for the attention of an operator.

In a variant embodiment of the subject matter disclosed herein, at least one slave 32 or master 34 RFID tag of the management system comprises measurement means 25, for measuring the temperature, atmospheric pressure, electrical consumption, noise level type or any other measurement sensor. The sensor is incorporated into the RFID tag 32, 34.

Alternatively, for reasons of limited space inside the RFID tag 32, 34, the sensor is separate from the RFID tag 32, 34 and interfaced with the latter. An example of an interface is an IC² bus. This advantageously makes it possible to remove the sensor if needed.

The measurement means 25 is able to insert the atmospheric measurements thus obtained into the series of data 9, 19 of the RFID tag 32, 34. Thus, the surroundings measurement(s) can be transmitted to a reader 22.

If the RFID tag 32, 34 that comprises a measurement means 25 is passive, a measurement can only be performed when the RFID tag 32, 34 is activated, i.e. only during an interrogation by a reader 22. In order to be able to lift this restriction and to be able to perform an atmospheric measurement at some other moment, a sensor, a measurement means 25 or else an RFID tag 32,34 can advantageously comprise its own independent power supply, for example by a battery, and thus be active or semi-active.

Although the management system according to the subject matter disclosed herein has been described with particular RFID tags, modifications can be envisaged without altering the spirit of the subject matter disclosed herein. Thus, in a variant embodiment, the connector 7 of the master or slave RFID tag is replaced by a cable on a permanent basis, thus making it possible to link this RFID tag to a corresponding slave or master RFID tag 34. In such an example, the operator does not have to take any cables in order to ensure the various connections. In another variant embodiment, the connection detection mechanism, included in a slave or in a master RFID tag, is linked to the switch via an electronic and/or software processing module.

1. A management system for managing a plurality of equipment stored in a plurality of housings, the management system comprising a reader, a plurality of RFID tags of a first type, denoted slave, each comprising a transmitter and a plurality of RFID tags of a second type, denoted master, each comprising a transmitter, each housing comprising an RFID tag of one type, either master or slave, and each equipment comprising an RFID tag of the other type connected via a connector to the RFID tag of the housing in which the equipment is stored, and in that the RFID tag of the master type is configured to transmit to the reader a series of data output by the slave RFID tag to which it is connected and a series of data output by the master RFID tag, in response to a request of the reader.

2. The management system according to claim 1, wherein each housing comprises a slave RFID tag and each equipment comprises a master RFID tag.

3. A management system according to claim 1, comprising a connector on each slave RFID tag configured to receive:
the connector; or
a free connector, denoted inhibitor, configured to be connected to the connector.

4. The management system according to claim 3, wherein each slave RFID tag comprises:
a mechanism for detecting a connection on the connector;
an inhibitor configured to deactivate the transmitter of the RFID tag, in the event of a connection being detected on the connector; and
a sender configured to send a series of data in response to a request from the reader, in the event of a connection on the connector.

5. The management system according to claim 1, wherein each master RFID tag comprises:
a receiver configured to receive, via the connector, a series of data originating from the slave RFID tag connected to the master RFID tag;
a mechanism for detecting a connection of the receiver; and
a concatenator configured to concatenate the series of data received from the slave RFID tag with another series of data into a concatenated series of data, intended to be transmitted to the reader in response to a request from the reader.

6. The management system according to claim 4, wherein at least one of the master RFID tags comprises the connector for connecting to the slave RFID tag.

7. The management system according to claim 1, wherein the connector is chosen from among a cable and a jumper wire.

8. A method for managing a plurality of equipment stored in a plurality of housings, the management method implementing a management system according to claim 1 and comprising emitting a request in the direction of a housing and of the reader receiving a series of data, the method comprising, for each housing receiving an equipment, a step of connecting the RFID tag associated with the housing:
to the RFID tag associated with the equipment stored in the housing; or
to an inhibitor.

9. The method according to claim 8, comprising, for each equipment stored in a housing, subsequently to the step of connecting the RFID tag associated with the housing, a step of the master RFID tag concatenating a series of data received from the slave RFID tag with a series of data output by the slave RFID tag.
